(19) United States
(12) Patent Application Publication
(10) Pub. No.: US 2006/0266391 A1
(43) Pub. Date: Nov. 30, 2006

(54) ARRANGEMENT FOR PREVENTING SEDIMENT FROM DEPOSITING IN NOZZLE OF STEAM CLEANER

(75) Inventor: Ching-Hsiang Wang, Tainan (TW)

Correspondence Address: NIKOLAI & MERSEREAU, P.A., 900 SECOND AVENUE SOUTH, SUITE 820, MINNEAPOLIS, MN, 55402, US

(73) Assignee: EUCORE ENTERPRISES CO., LTD., Tainan (TW)

(21) Appl. No.: 10/908,848

(22) Filed: May 27, 2005

(51) Int. Cl. B08B 3/00; B08B 3/12

(52) U.S. Cl. 134/105; 134/198

(57) ABSTRACT

A steam cleaner comprises a water reservoir; a heater including a supply pipeline, a first steam pipeline spaced from the supply pipeline, and a sediment catching space between the supply pipeline and the first steam pipeline; a steam chamber with a portion of the first steam pipeline disposed therein; and a nozzle including a second steam pipeline partially disposed in the steam chamber and spaced from the first steam pipeline. Water is drawn out of the water reservoir to the heater for heating, steam is generated in the heater and flows out of the supply pipeline into the first steam pipeline through the sediment catching space with solid particles therein being deposited in the sediment catching space to form sediment and remaining steam flowing into the second steam pipeline through the steam chamber, and the steam is shot out from the nozzle. The invention prevents sediment from blocking the nozzle.

### BACKGROUND OF THE INVENTION

1. Field of Invention

The present invention relates to steam cleaners and more particularly to such a steam cleaner having an arrangement for forming sediment therein rather than in its nozzle.

2. Related Art

A conventional steam cleaner comprises a housing, a water reservoir integral with the housing, a heater in fluid communication with the water reservoir through a supply pipeline, a steam pipeline extended from the heater, and a nozzle at the end of the steam pipeline.

In operation, cold water is drawn out of the water reservoir to the heater through the supply pipeline. In the heater, water is heated to generate steam. Eventually, steam is shot out onto an object to be cleaned from the nozzle through the steam pipeline. Preferably, one or more auxiliary tools (e.g., brush, cotton, or the like) are used in cooperation with the cleaning.

However, solid particles in the steam tend to deposit in the nozzle to form sediment. It is known that steam flow through the nozzle may be reduced or even blocked if sediment is sufficiently large in size. Thus, the need for improvement still exists.

### SUMMARY OF THE INVENTION

It is therefore an object of the present invention to provide a steam cleaner having an arrangement for forming sediment therein rather than in its nozzle so as to prevent sediment from blocking the nozzle.

The above and other objects of the present invention are realized by providing a steam cleaner enclosed by a housing and comprises a water reservoir at one end, a heater, a steam chamber at the other end of the housing, and a nozzle projected from the other end of the housing. The heater includes a supply pipeline interconnected the water reservoir and the heater, a first steam pipeline, and a sediment catching space between the supply pipeline and the first steam pipeline. A height difference is provided between the supply pipeline and the first steam pipeline and an outlet of the supply pipeline and an inlet of the first steam pipeline are staggered. The steam chamber includes a steam storage space with a predetermined portion of the first steam pipeline disposed therein. A height difference is provided between the first steam pipeline and the second steam pipeline and an inlet of the first steam pipeline and an outlet of the second steam pipeline are staggered. The nozzle includes a second steam pipeline partially disposed in the steam storage space, wherein water is adapted to be drawn out of the water reservoir to the heater for heating through the supply pipeline by activating the pump, steam is generated in the heater and flows out of the supply pipeline into the first steam pipeline through the sediment catching space with solid particles therein being deposited in the sediment catching space to form sediment and remaining steam flowing out of the first steam pipeline into the second steam pipeline through the steam storage space, and the steam is shot out from the nozzle through the second steam pipeline.

The above and other objects, features and advantages of the present invention will become apparent from the following detailed description taken with the accompanying drawings.

### BRIEF DESCRIPTION OF THE DRAWINGS

FIG. 1 is a sectional view of a preferred embodiment of steam cleaner according to the invention; and

FIG. 2 is a view similar to FIG. 1 showing a fluid flow therein and a steam shooting out in an operating state.

### DETAILED DESCRIPTION OF THE INVENTION

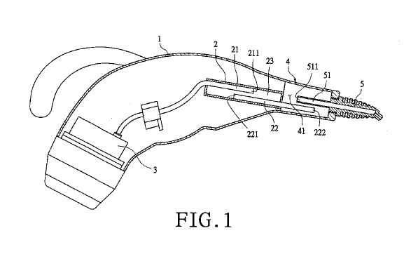

Referring to FIG. 1, there is shown a steam cleaner constructed in accordance with a preferred embodiment of the invention. The steam cleaner is enclosed by a housing 1 and comprises a water reservoir 3 at one end, a heater 2, a steam chamber 4 at the other end of the housing 1, and a nozzle 5 projected from the other end of the housing 1. The heater 2 includes a supply pipeline 21 interconnected the water reservoir 3 and the heater 2, a first steam pipeline 22 spaced from the supply line 21 by a distance, and a sediment catching space 23 between the supply pipeline 21 and the first steam pipeline 22. The steam chamber 4 includes a steam storage space 41 with a portion of the first steam line 22 disposed therein. The nozzle 5 includes a second steam pipeline 51 having a portion disposed in the steam storage space 41 and spaced from the first steam pipeline 22 by a distance.

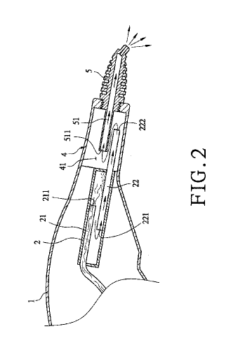

Referring to FIG. 2, steam shooting out of the steam cleaner will be described in detailed below. In operation, cold water is drawn out of the water reservoir 3 to the heater 2 through the supply pipeline 21. In the heater 2, water is heated to generate steam. Steam then flows out of an outlet 211 of the supply pipeline 21 into an inlet 221 of the first steam pipeline 22 through the sediment catching space 23. There is a height difference between the supply pipeline 21 and the first steam pipeline 22. Further, the outlet 211 of the supply pipeline 21 and the inlet 221 of the first steam pipeline 22 are staggered. Solid particles in steam may deposit in the sediment catching space 23 to form sediment and remaining steam flows into the first steam pipeline 22 because the sediment catching space 23 is located between the outlet 211 of the supply pipeline 21 and the inlet 221 of the first steam pipeline 22 in the steam flow. Next, steam flows out of an outlet 222 of the first steam pipeline 22 into an inlet 511 of the second steam pipeline 51 through the steam storage space 41. There is a height difference between the first steam pipeline 22 and the second steam pipeline 51 and the inlet 221 of the first steam pipeline 22 and the outlet 511 of the second steam pipeline 51 are staggered. so as to centralize steam in the steam storage space 41. Eventually, steam is shot out onto an object to be cleaned from the nozzle 5 through the second steam pipeline 51. As an end, the purpose of preventing sediment from depositing in the nozzle 5 is achieved.

While the invention herein disclosed has been described by means of specific embodiments, numerous modifications and variations could be made thereto by those skilled in the art without departing from the scope and spirit of the invention set forth in the claims.

What is claimed is:

1. A steam cleaner comprising:
a water reservoir at one end;
a heater including a supply pipeline interconnected the water reservoir and the heater, a first steam pipeline and a sediment catching space between the supply pipeline and the first steam pipeline;
a steam chamber at the other end and including a steam storage space with a predetermined portion of the first steam pipeline disposed therein; and
a nozzle projected from the other end and including a second steam pipeline partially disposed in the steam storage space and spaced from the first steam pipeline by a second distance,
wherein water is adapted to be drawn out of the water reservoir to the heater for heating through the supply pipeline, steam is generated in the heater and flows out of the supply pipeline into the first steam pipeline through the sediment catching space with solid particles therein being deposited in the sediment catching space to form sediment and remaining steam flowing out of the first steam pipeline into the second steam pipeline through the steam storage space, and the steam is shot out from the nozzle through the second steam pipeline.

2. A steam cleaner of claim 1, wherein a height difference is provided between the supply pipeline and the first steam pipeline and an outlet of the supply pipeline and an inlet of the first steam pipeline are staggered.

3. A steam cleaner of claim 1, wherein a height difference is provided between the first steam pipeline and the second steam pipeline and an inlet of the first steam pipeline and an outlet of the second steam pipeline are staggered.
